(19) United States
(12) Patent Application Publication
(10) Pub. No.: US 2010/0286989 A1
(43) Pub. Date: Nov. 11, 2010

(54) RECORDING/REPRODUCTION DEVICE

(76) Inventors: Shingo Urata, Nara (JP); Takayuki Kawanishi, Hyogo (JP); Takeshi Fujita, Osaka (JP); Shuhei Yamada, Osaka (JP); Miki Yamashita, Kyoto (JP)

Correspondence Address: MCDERMOTT WILL & EMERY LLP, 600 13TH STREET, NW, WASHINGTON, DC, 20005-3096, US

(21) Appl. No.: 12/810,947

(22) PCT Filed: Dec. 5, 2008
(86) PCT No.: PCT/JP2008/003634

§ 371 Date: Jun. 28, 2010

(30) Foreign Application Priority Data
Jan. 16, 2008 (JP) 2008-006486

(51) Int. Cl. G06F 17/00; G10L 21/00

(52) U.S. Cl. 704/500; 700/94

(57) ABSTRACT

An audio data processor (120) performs a decoding process and a compression (encoding) process with respect to audio data in units of frames each containing a predetermined number of samples. The resultant encoded data is temporarily accumulated in an encoded data buffer (110). A song boundary detector (106) detects a frame boundary which should be used as a song boundary based on song position information corresponding to the audio data and feature information output from a feature extraction signal processor (107). A frame boundary divider (111) modifies the encoded data accumulated in the encoded data buffer so that a frame boundary of the encoded data matches the detected frame boundary.

### TECHNICAL FIELD

The present invention relates to techniques of encoding digital sound data.

### BACKGROUND ART

In recent years, various techniques have been developed to compress (encode) audio data signals, such as speech, music, and the like, at a low bit rate and decompress (decode) the compressed signals during playback for the purpose of meeting a demand of users for an easy way to listen to music. As a representative technique, MP3 (MPEG-1 audio layer III) is known.

According to a certain conventional technique, a plurality of songs having different song numbers in a live CD in which there is no gap of silence between songs are continuously compressed (encoded) and recorded into a single music file, and information about the start positions of the songs is recorded into another file. When a song is played back by designating a corresponding song number, the position information file is referenced to start playback of the designated song in the music file (see PATENT DOCUMENT 1).

### CITATION LIST

### Patent Document

PATENT DOCUMENT 1: Japanese Patent Laid-Open Publication No. 2004-93729

### SUMMARY OF THE INVENTION

### Technical Problem

There is still a demand of users for a technique of, when audio data stored on a CD or the like is encoded by MP3 or the like before being recorded, dividing the encoded data according to song numbers and recording the divided encoded data.

Here, audio data on a CD is divided into sectors each containing 588 samples. A track boundary is one of sector boundaries. On the other hand, encoding is performed in units different from sectors. For example, for MP3 streams, encoding is performed in units of frames each containing 1152 samples. Therefore, in most cases, the track boundaries of audio data do not match the dividing positions of the MP3 stream of the audio data. As a result, when an MP3 stream is divided into units of songs, track boundaries of a CD cannot be directly used as dividing positions of individual song files of the MP3 stream (a song file contains a song).

If frame boundaries of an MP3 stream which are close to track boundaries of a CD are used as dividing positions of song files, songs are separated from each other at a position which is not an original boundary between the songs. Therefore, sound in the beginning of a song may appear in the end of the previous song, or sound in the end of a song may appear in the beginning of the next song. For some songs on CDs, the end of a song may contain no sound and the beginning of the next song may contain sound, or the end of a song may contain sound and the beginning of the next song may contain no sound. In such a case, when songs are played back from an MP3 stream, sound in the beginning of a song may be heard in the end of the previous song, or sound in the end of a song may be heard in the beginning of the next song. Such sound is likely to be recognized as noise.

The present invention has been made in view of the aforementioned problems. It is an object of the present invention to provide a recording/reproduction device for reproducing and recording audio data which reduces or prevents insertion of sound which is recognized as noise into the beginning or end of a song, in encoded data which is obtained by compressing (encoding) audio data.

### Solution to the Problem

A recording/reproduction device according to the present invention includes an audio data processor configured to perform a decoding process for reproduction and a compression/encoding process for recording with respect to audio data in units of frames each containing a predetermined number of samples, an encoded data buffer configured to temporarily accumulate encoded data output from the audio data processor, a feature extraction signal processor configured to perform a signal process with respect to the audio data to extract feature information indicating a feature of the audio data, a song boundary detector configured to receive song position information corresponding to the audio data and the feature information output from the feature extraction signal processor, and based on the song position information and the feature information, detect a frame boundary which should be used as a song boundary, and a frame boundary divider configured to, when the song boundary detector detects a frame boundary which should be used as a song boundary, modify the encoded data accumulated in the encoded data buffer so that a frame boundary of the encoded data matches the detected frame boundary which should be used as a song boundary.

According to the recording/reproduction device of the present invention, the audio data processor performs the decoding process for reproduction and the compression (encoding) process for recording with respect to input audio data in units of frames each containing a predetermined number of samples. The resultant encoded data is temporarily accumulated in the encoded data buffer. The song boundary detector detects a frame boundary which should be used as a song boundary, based on song position information corresponding to the audio data and the feature information indicating a feature of the audio data which is extracted by the feature extraction signal processor. When a frame boundary which should be used as a song boundary has been detected, the frame boundary divider performs a process of modifying the encoded data accumulated in the encoded data buffer so that a frame boundary of the encoded data matches the detected frame boundary. As a result, the frame boundary of the encoded data matches the frame boundary of the audio data which should be used as a song boundary, whereby it is possible to reduce or prevent insertion of sound in the beginning of a song into the end of the next song, and insertion of sound in the end of a song into the beginning of the previous song.

### ADVANTAGES OF THE INVENTION

According to the present invention, in a recording/reproduction device which performs a decoding process for reproduction and a compression (encoding) process for recording with respect to audio data, a frame boundary of encoded data matches a frame boundary of audio data which should be used as a song boundary, whereby it is possible to reduce or prevent insertion of sound in the beginning of a song into the end of the next song, and insertion of sound in the end of a song into the beginning of the previous song, which are likely to be recognized as noise.

### BRIEF DESCRIPTION OF THE DRAWINGS

FIG. 1 is a diagram schematically showing a configuration of recording/reproduction devices according to first to third embodiments of the present invention.

FIG. 2 is a diagram showing example operation of the recording/reproduction device of the first embodiment.

FIG. 3 is a diagram showing example operation of the recording/reproduction device of the first embodiment.

FIG. 4 is a diagram showing example operation of the recording/reproduction device of the first embodiment.

FIG. 5 is a diagram showing example operation of the recording/reproduction device of the first embodiment.

FIG. 6 is a diagram showing example operation of the recording/reproduction device of the second embodiment.

FIG. 7 is a diagram schematically showing a configuration of a recording/reproduction device according to a fourth embodiment of the present invention.

### DESCRIPTION OF REFERENCE CHARACTERS

101, 101A Recording/Reproduction Device
102 Stream Controller
103 Buffer
104 Decoder
105 Encoder
106 Song Boundary Detector
107 Feature Extraction Signal Processor
108 SDRAM
109 Output Buffer
110 Encoded Data Buffer
111 Frame Boundary Divider
112 Host Interface
120 Audio Data Processor

### DESCRIPTION OF EMBODIMENTS

Embodiments of the present invention will be described hereinafter with reference to the accompanying drawings.

### First Embodiment

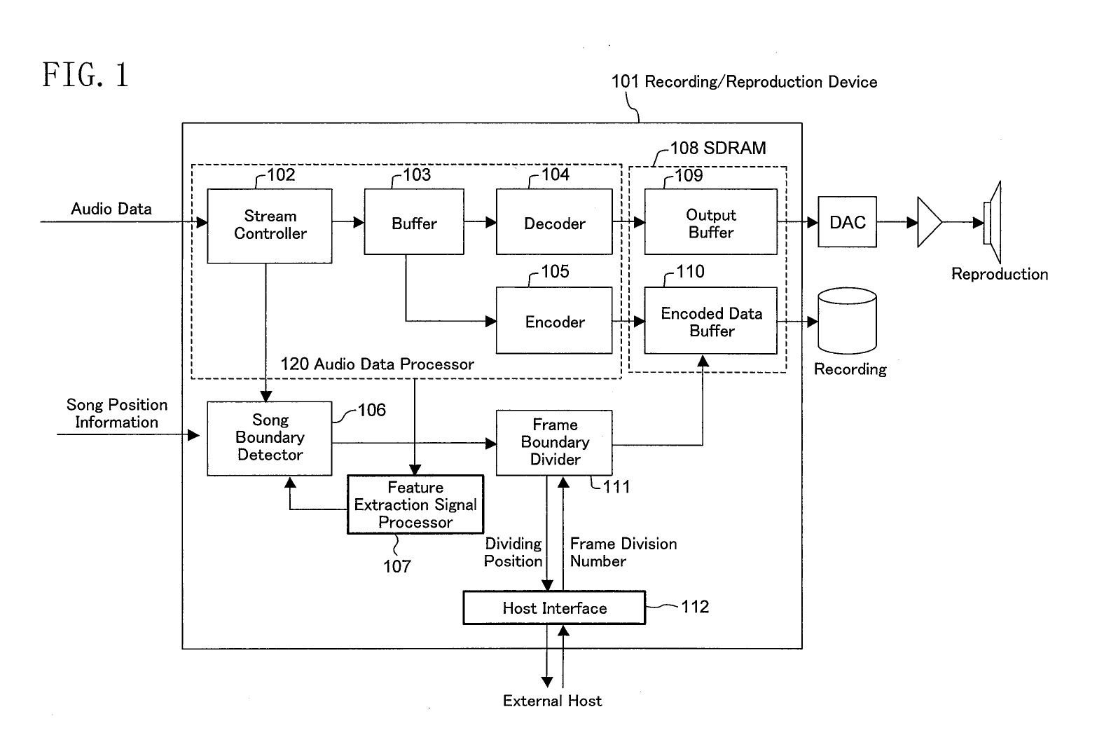

FIG. 1 is a diagram schematically showing a configuration of a recording/reproduction device according to a first embodiment of the present invention. The recording/reproduction device 101 of FIG. 1 reproduces input audio data, and at the same time, compresses (encodes) the audio data and records the resultant compressed data. In this embodiment, it is assumed that the audio data is recorded on a CD in the MP3 format, which is a compression (encoding) format.

In FIG. 1, the audio data processor 120 performs a decoding process for reproduction and a compression (encoding) process for recording with respect to the input audio data in units of frames each containing a plurality of samples (e.g., 1152 samples). The audio data processor 120 includes a stream controller 102 which fetches data from the audio data on a frame-by-frame basis and outputs the data, a buffer 103 which temporarily accumulates audio data output from the stream controller 102, a decoder 104 which fetches a frame of data from the buffer 103 and performs the decoding process for reproduction with respect to the frame of data, and an encoder 105 which fetches a frame of data from the buffer 103 and performs the compression (encoding) process for recording with respect to the frame of data. The data which is to be decoded by the decoder 104 and the data which is to be compressed (encoded) by the encoder 105 are the same data in the buffer 103.

An output buffer 109 temporarily accumulates decoded data output from the decoder 104 and outputs the decoded data at a constant rate. An encoded data buffer 110 temporarily accumulates encoded data output from the encoder 105 and outputs the encoded data to a semiconductor memory, a hard disk, or the like. The output buffer 109 and the encoded data buffer 110 are provided in an SRAM 108.

The recording/reproduction device 101 further includes a song boundary detector 106, a feature extraction signal processor 107, a frame boundary divider 111, and a host interface 112. Each component of the recording/reproduction device 101 performs processing in a time-division manner.

The feature extraction signal processor 107 performs a signal process with respect to audio data based on information obtained from the audio data processor 120 to extract feature information indicating a feature of the audio data. The feature extraction signal processor 107 notifies the song boundary detector 106 of the feature information. The song boundary detector 106 receives song position information corresponding to the audio data fetched by the audio data processor 120, and the feature information output from the feature extraction signal processor 107, and based on the song position information and the feature information, detects a frame boundary which should be used as a song boundary. The song boundary detector 106 notifies the frame boundary divider 111 of information about the detected frame boundary.

The frame boundary divider 111, when the song boundary detector 106 has detected a frame boundary which should be used as a song boundary, performs a process of modifying the encoded data accumulated in the encoded data buffer 110 so that a frame boundary of the encoded data matches the detected frame boundary which should be used as a song boundary. Specifically, for example, dummy data is inserted into the encoded data accumulated in the encoded data buffer 110 so that the frame boundary of the encoded data matches the detected frame boundary. Moreover, data indicating the frame boundary of the encoded data corresponding to the frame boundary detected as a song boundary, is output as a dividing position of the encoded data. Information about the dividing position is output via the host interface 112 to the outside of the recording/reproduction device 101.

On the other hand, in the case of the middle of a song, the song boundary detector 106 does not notify the frame boundary divider 111 of a frame boundary, and the frame boundary divider 111 does not particularly perform operation in this case. Although it is assumed in this embodiment that the division process is performed by an external host module, the division process may be performed by another module provided in the recording/reproduction device 101. In this case, information about a dividing position is transmitted to the internal module.

In this embodiment, the feature extraction signal processor 107 is assumed to extract a sound pressure level of audio data in the vicinity of a frame boundary as feature information. It is also assumed that the song boundary detector 106 utilizes a subcode recorded on a CD as song position information. In CDs, a subcode containing a song number or the like is recorded in each sector containing a predetermined number of samples (e.g., 588 samples) of audio data. Moreover, the number of samples or data size of audio data, the playback duration of a song, or the like may be utilized as song position information.

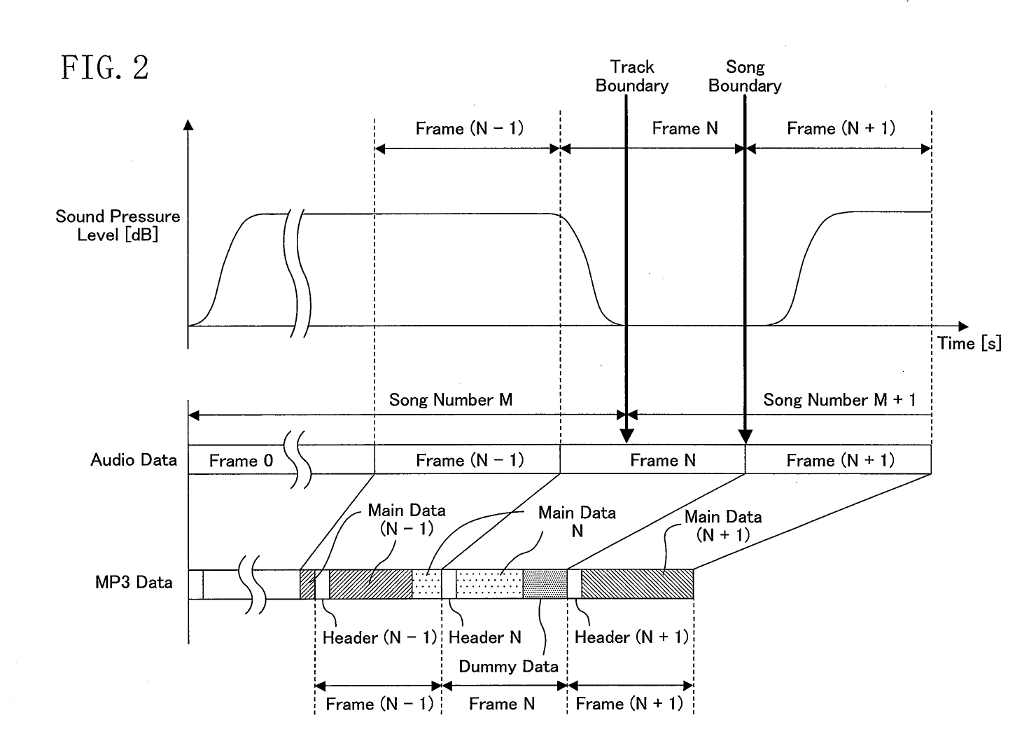

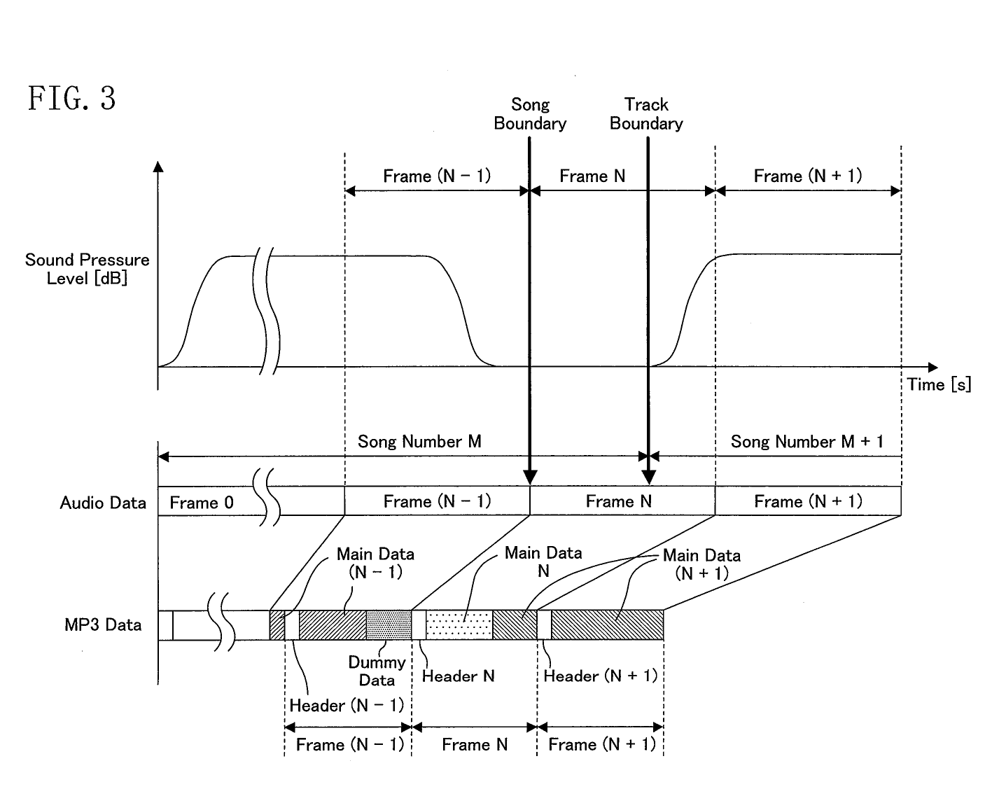

FIGS. 2 and 3 are diagrams of operation of the recording/reproduction device of this embodiment, showing audio data and sound pressure levels thereof, and MP3 data as an example of encoded data. According to the MP3 format, audio data is encoded in units of frames to generate MP3 data containing a header and main data. A frame of MP3 data ranges from the start end of a header to the start end of the next header. The data size of a frame is determined by the bit rate of MP3 data.

In FIGS. 2 and 3, it is assumed that a track boundary between a song number M and a song number (M+1) is present in a frame N of audio data (M and N are natural numbers).

In audio data shown in FIG. 2, there is sound (no silence) at a boundary between the frame (N−1) and the frame N, and there is silence at a boundary between the frame N and the frame (N+1). In this case, if the boundary between the frame (N−1) and the frame N is used as a song boundary, sound of the song M appears in the beginning of the song (M+1), and is recognized as noise. Therefore, in the example of FIG. 2, it is preferable that the boundary between the frame N and the frame (N+1) be used as a song boundary.

On the other hand, in audio data shown in FIG. 3, there is silence at a boundary between the frame (N−1) and the frame N, and there is sound (no silence) at a boundary between the frame N and the frame (N+1). In this case, if the boundary between the frame N and the frame (N+1) is used as a song boundary, sound of the song (M+1) appears in the end of the song M, and is recognized as noise. Therefore, in the example of FIG. 3, it is preferable that the boundary between the frame (N−1) and the frame N be used as a song boundary.

Therefore, in this embodiment, the song boundary detector 106 operates to utilize information about the sound pressure level of audio data in the vicinity of a frame boundary, which is extracted by the feature extraction signal processor 107, thereby detecting the boundary between the frame N and the frame (N+1) as a song boundary in the case of FIG. 2, or detecting the boundary between the frame (N−1) and the frame N as a song boundary in the case of FIG. 3.

A process of the song boundary detector 106 will be described in detail. The song boundary detector 106 reads, as song position information, a subcode corresponding to audio data fetched by the stream controller 102. The feature extraction signal processor 107 calculates an average value (indicating a sound pressure level) of several samples of audio data at a frame boundary position, and outputs the average value as feature information to the song boundary detector 106. Note that the feature information read by the song boundary detector 106 is not limited to the average value of the sound pressure levels of audio samples at a frame boundary position. The song boundary detector 106 detects a frame boundary which should be used as a song boundary, based on a song number contained in the subcode and the average value of audio samples.

Initially, when a frame 0 of audio data is fetched by the stream controller 102, the song boundary detector 106 reads a subcode corresponding to the frame 0 of the audio data. Because the frame 0 of the audio data is the first input data after the recording/reproduction device 101 is activated, the song number M of the frame 0 is an initial song number value.

Subsequently, every time the stream controller 102 fetches a frame (1 to N) of the audio data, the song boundary detector 106 reads a subcode corresponding to the frame of the audio data to determine a song number. In each of the frames 0 to (N−1), because the song number of the current frame is equal to the song number of the next frame, the song boundary detector 106 determines that the current frame is in the middle of a song.

When the stream controller 102 fetches the frame N and the frame (N+1) of the audio data, the song boundary detector 106 reads subcodes corresponding to the frame N and the frame (N+1). Because the song number of the frame N is M and the song number of the frame (N+1) is (M+1), the song boundary detector 106 performs a determination with reference to the average value of audio samples at a frame boundary position of which the feature extraction signal processor 107 notifies the song boundary detector 106.

In the example of FIG. 2, the average value of audio samples at the start boundary of the frame N indicates the presence of sound, and the average value of audio samples at the end boundary of the frame N indicates the absence of sound. In this case, if the start boundary of the frame N, i.e., the boundary between the frame (N−1) and the frame N is used as a song boundary, noise is inserted into the beginning of the song (M+1). Therefore, the frame N is determined to be in the middle of a song, and the end boundary of the frame N, i.e., the boundary between the frame N and the frame (N+1) is detected as a song boundary. In other words, the frame N is determined to be contained in the song M.

On the other hand, in the example of FIG. 3, the average value of audio samples at the start boundary of the frame N indicates the absence of sound, and the average value of audio samples at the end boundary of the frame N indicates the presence of sound. In this case, if the end boundary of the frame N, i.e., the boundary between the frame N and the frame (N+1) is used as a song boundary, noise is inserted into the end of the song M. Therefore, the start boundary of the frame N, i.e., the boundary between the frame (N−1) and the frame N is detected as a song boundary. In other words, the frame N is determined to be contained in the song (M+1).

A process of the frame boundary divider 111 will be described. When the song boundary detector 106 does not notify the frame boundary divider 111 of song boundary information, the frame boundary divider 111 does not particularly perform operation. Therefore, encoded data output from the encoder 105 is directly stored into the encoded data buffer 110.

On the other hand, when the song boundary detector 106 detects a frame boundary which should be used as a song boundary, the frame boundary divider 111 receives information about the frame boundary from the song boundary detector 106, and performs a process of inserting dummy data into MP3 data stored in the encoded data buffer 110. As a result, the MP3 data is modified so that the frame boundary of audio data which should be used as a song boundary matches a frame boundary of the MP3 data.

For example, in the example of FIG. 2, dummy data is inserted between the tail end of main data N which is obtained by encoding the frame N of the audio data, and the start end of a header (N+1), and the size of main data (N+1) which is obtained by encoding the frame (N+1) of the audio data and can be inserted into the frame N of the MP3 data, is set to zero. Thereafter, when the frame (N+1) of the audio data is encoded by the encoder 105, the resultant main data (N+1) is placed from the tail end of the header (N+1).

In the example of FIG. 3, dummy data is inserted between the tail end of main data (N−1) which is obtained by encoding the frame (N−1) of the audio data and the start end of a header N, and the size of main data N which is obtained by encoding the frame N of the audio data and can be inserted into the frame (N−1) of the MP3 data, is set to zero. Thereafter, when the frame N of the audio data is encoded by the encoder 105, the resultant main data N is placed from the tail end of the header N.

As a result, in the example of FIG. 2, the MP3 data can be divided at the start end of the header (N+1), and the header (N+1) and the following portions constitute the MP3 data of the song (M+1). In the example of FIG. 3, the MP3 data can be divided at the start end of the header N, and the header N and the following portions constitute the MP3 data of the song (M+1).

Moreover, the frame boundary divider 111 outputs data indicating a frame boundary of MP3 data which is a song boundary, as a dividing position of the MP3 data. In the example of FIG. 2, the frame boundary divider 111 outputs the leading address of the header (N+1) in the encoded data buffer 110 as a dividing position. In the example of FIG. 3, the frame boundary divider 111 outputs the leading address of the header N in the encoded data buffer 110 as a dividing position. The dividing position output from the frame boundary divider 111 is transmitted via the host interface 112 to the outside of the recording/reproduction device 101.

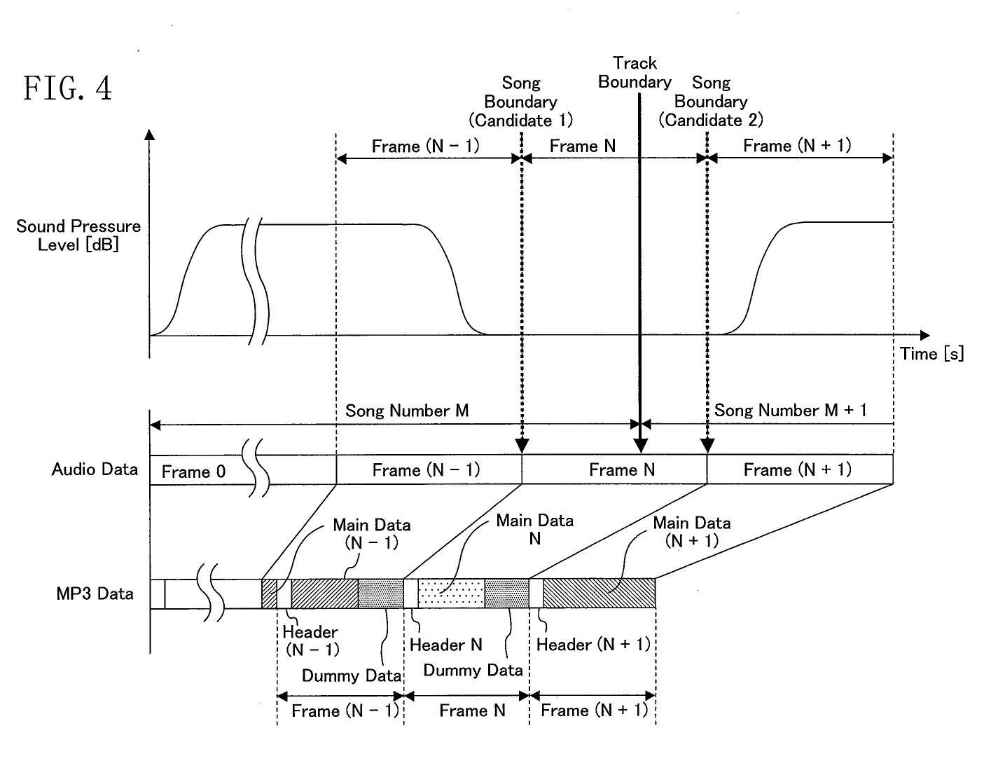

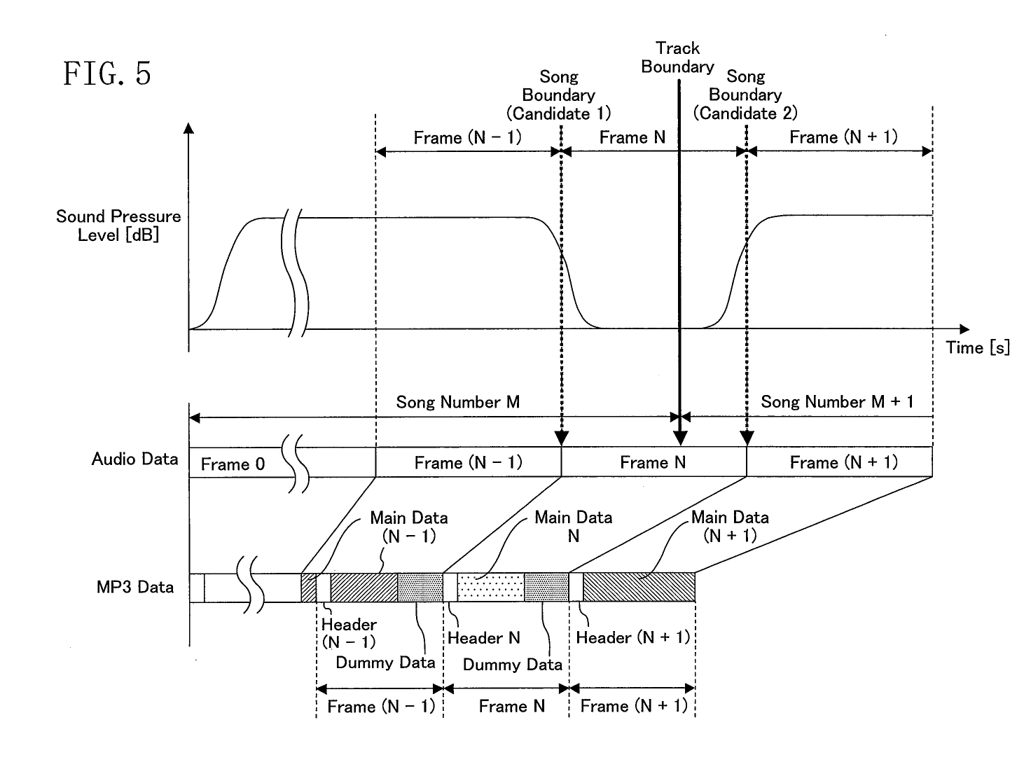

Note that audio samples may indicate the absence of sound at both the start and end boundaries of the frame N as shown in FIG. 4, or may indicate the presence of sound at both the start and end boundaries of the frame N as shown in FIG. 5. In the case of FIG. 4, noise is not inserted no matter whether the start or end boundary of the frame N is used as a song boundary. In the case of FIG. 5, noise is inserted no matter whether the start or end boundary of the frame N is used as a song boundary. In this case, the song boundary detector 106 may notify the frame boundary divider 111 of a plurality of candidates for a song boundary.

In the case of FIGS. 4 and 5, the frame boundary divider 111, when notified of both the start and end boundaries of the frame N as candidates for a song boundary, inserts dummy data into two portions, i.e., between the tail end of the main data (N−1) and the start end of the header N, and between the tail end of the main data N and the start end of the header (N+1). As a result, the encoded data can be divided at the start ends of the header N and the header (N+1). The frame boundary divider 111 outputs the leading addresses of the headers N and (N+1) in the encoded data buffer 110 as dividing positions of the encoded data. In this case, the external module which perform the division process can select any of the output dividing positions. Also, the frame boundary divider 111 may additionally output information which may be helpful to select a dividing position. Note that it is preferable that the number of dividing positions of which the external module is notified can be designated, as a frame division number, by the external module.

As described above, according to the recording/reproduction device 101 of FIG. 1, even when pieces of audio data having different song numbers are continuously input, the encoded data can be divided and recorded according to the song numbers without interruption of playback.

The song boundary detector 106 detects a frame boundary which should be used as a song boundary, based on song position information corresponding to audio data, and feature information indicating a feature of the audio data, which is extracted by the feature extraction signal processor 107. When a frame boundary which should be used as a song boundary is detected, the frame boundary divider 111 performs a process of modifying encoded data accumulated in the encoded data buffer 110 so that a frame boundary of the encoded data matches the detected frame boundary. As a result, the frame boundary of the encoded data matches the frame boundary of the audio data which should be used as a song boundary, and therefore, it is possible to reduce or prevent insertion of sound in the beginning of a song into the end of the previous song, and insertion of sound in the end of a song into the beginning of the next song. Therefore, it is possible to reduce or prevent insertion of sound which is recognized as noise into the beginning or end of a song, in encoded data which is obtained by compressing (encoding) audio data.

### Second Embodiment

A recording/reproduction device according to a second embodiment of the present invention has a configuration similar to that of the first embodiment of FIG. 1. The components of the recording/reproduction device of the second embodiment perform processes similar to those of the first embodiment, except for the song boundary detector 106 and the feature extraction signal processor 107. Here, only differences will be described.

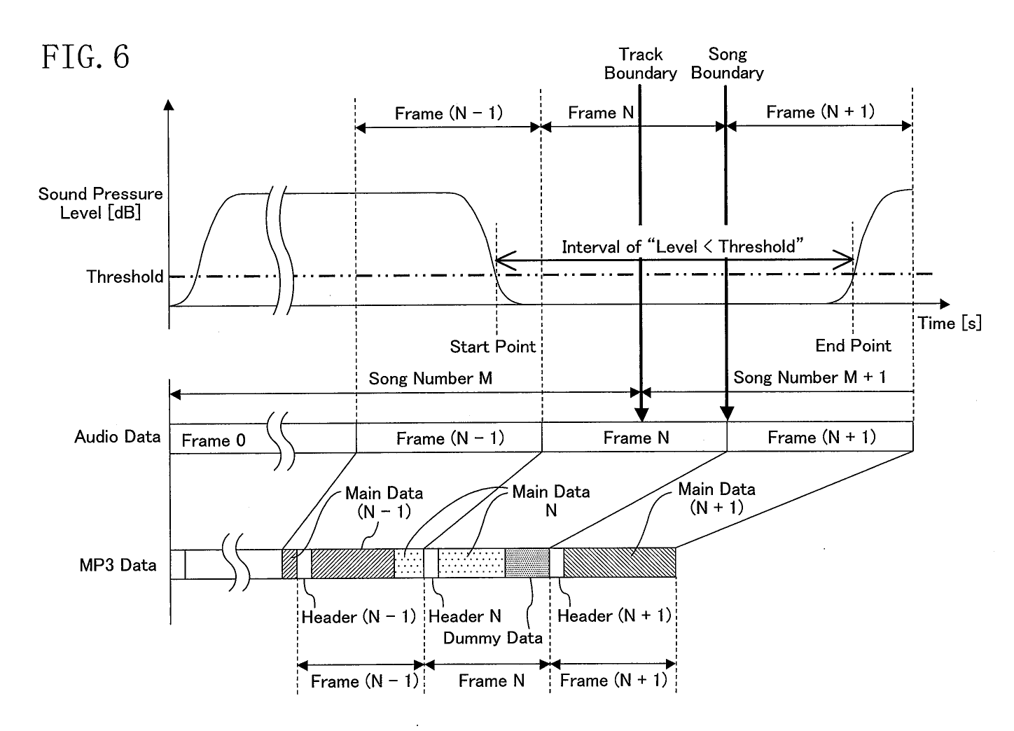

FIG. 6 is a diagram of operation of the recording/reproduction device of this embodiment, showing audio data and sound pressure levels thereof, and MP3 data as an example of encoded data. Processes of the song boundary detector 106 and the feature extraction signal processor 107 of this embodiment will be described with reference to FIG. 6.

In this embodiment, the feature extraction signal processor 107 extracts temporal transition information indicating temporal transition of the sound pressure level of audio data, as feature information indicating a feature of the audio data. Specifically, for example, the feature extraction signal processor 107 compares the sound pressure level with a predetermined threshold, and based on the result of the comparison, calculates the start point and the end point of an interval in which the sound pressure level is lower than the predetermined threshold.

The song boundary detector 106 receives the start and end points of the interval in which the sound pressure level is lower than the predetermined threshold, as feature information, from the feature extraction signal processor 107. The song boundary detector 106 detects a frame boundary farther from the start or end point as a song boundary. In the example of FIG. 6, the time length from the end point of the interval of “level<threshold” to the end boundary of a frame N is greater than the time length from the start point of the interval of “level<threshold” to the start boundary of the frame N. Therefore, the song boundary detector 106 detects, as a song boundary, the end boundary of the frame N, i.e., the boundary between the frame N and the frame (N+1).

Although it has been assumed above that the start or end point is compared with a frame boundary, a track boundary may be used instead of a frame boundary. For example, the time lengths from a track boundary to the start and end points of the interval of “level<threshold” are calculated. A frame boundary on a side having the longer time length of the interval (in the case of FIG. 6, the boundary between the frame N and the frame (N+1)) may be detected as a song boundary. Alternatively, a frame boundary on a side having the shorter time length of the interval may be detected as a song boundary.

Although it has also been assumed above that the sound pressure level is used as a feature amount of audio data, other feature amounts may be used. For example, the feature extraction signal processor 107 may extract a frequency characteristic of audio data as a feature amount, calculate a similarity between the frequency characteristic and predetermined characteristic, and detect an interval in which the similarity is lower than a predetermined threshold. Such feature information can be used to determine a song boundary. Alternatively, level information in a specific frequency band may be extracted as a feature amount and compared with a predetermined threshold.

Note that, in this embodiment, the frequency characteristic and the level information in a specific frequency band can be obtained based on the result of a frequency analysis process performed by the decoder 104 or the encoder 105.

Although it has also been assumed above that the start and end points of an interval in which a feature amount is lower than a predetermined threshold are detected as temporal transition information indicating temporal transition of a feature amount of audio data based on the result of comparison between the feature amount and a predetermined threshold, the form of temporal transition information is not limited to this. For example, feature amounts of audio data corresponding to several frames or an arbitrary number of samples are obtained to calculate the tendency of changes with time of the feature amounts as temporal transition information. As an example, a time required for a feature amount of audio data to converge may be estimated, and based on the time, a song boundary may be detected.

### Third Embodiment

A recording/reproduction device according to a third embodiment of the present invention has a configuration similar to that of the first embodiment of FIG. 1. The components of the recording/reproduction device of the third embodiment perform processes similar to those of the first and second embodiments, except for the song boundary detector 106 and the feature extraction signal processor 107. Here, only differences will be described.

In this embodiment, the feature extraction signal processor 107 performs physical characteristic analysis with respect to audio data to obtain the result of the analysis, such as level information, a frequency characteristic, or the like. A feature amount of audio data here obtained may include at least one of the result of determination of whether the audio data is audio or non-audio, tempo information, and timbre information, or may be a combination of analysis results. The feature extraction signal processor 107 extracts a change with time in the result of the analysis as temporal transition information indicating temporal transition of the feature amount of audio data. Note that, as described in the second embodiment, the result of frequency analysis performed in the decoder 104 or the encoder 105 may be utilized.

The song boundary detector 106 detects a song boundary based on the change with time in the result of the analysis which are extracted by the feature extraction signal processor 107. For example, a sharp change in the result of the analysis or a point containing specific audio may obtained and determined to be a song boundary by analogy.

### Fourth Embodiment

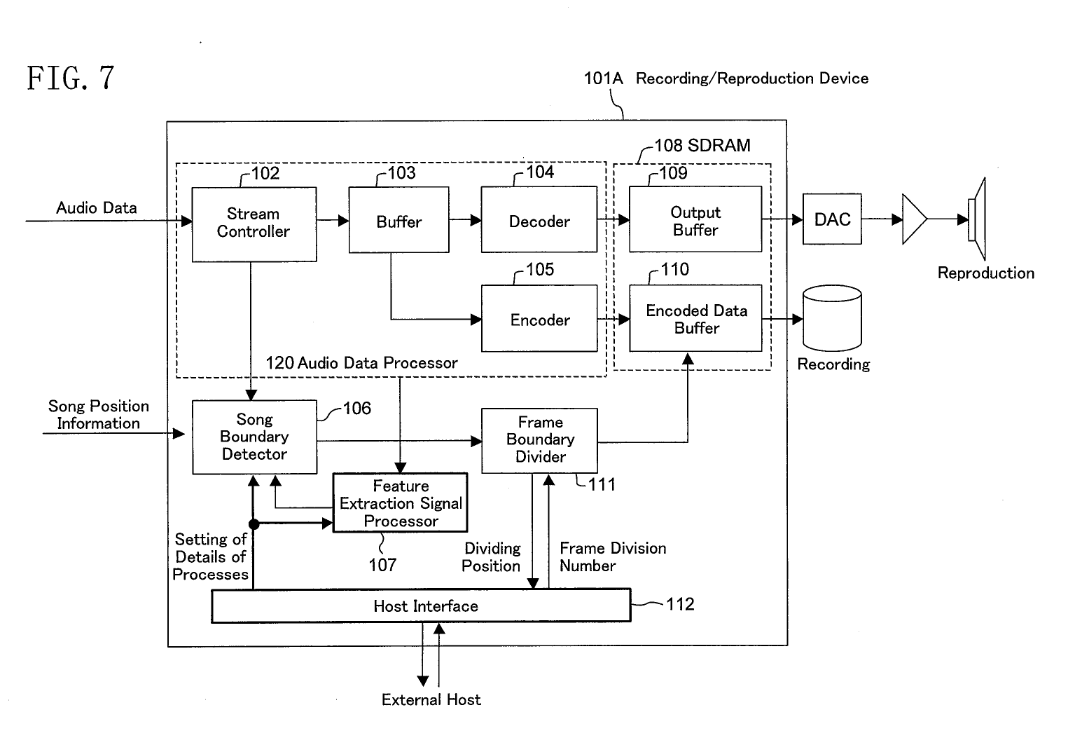

FIG. 7 is a diagram schematically showing a configuration of a recording/reproduction device according to a fourth embodiment of the present invention. The configuration of FIG. 7 is almost similar to that of FIG. 1. The same components as those of FIG. 1 are indicated by the same reference characters and will not be here described in detail.

This embodiment is different from the first to third embodiments in that the processes of the song boundary detector 106 and the feature extraction signal processor 107 can be set via the host interface 112 from the outside of the recording/reproduction device 101A.

When reproduction and encoding processes of audio data are started, details of the encoding process, such as an audio encoding scheme and a sampling frequency after encoding, the start-to-end region of a buffer, a frame division number, and the like, are externally set via the host interface 112 into the song boundary detector 106. After the setting, the reproduction and encoding processes of audio data are performed. During the processes, the song boundary detector 106 receives a dividing position of a frame boundary from the frame boundary divider 111. When the reproduction and encoding processes of audio data are stopped, the stopping process is performed based on the dividing position.

For example, the following settings may be externally made via the host interface 112.
When the input is music data, a process, such as that shown in the first embodiment, is performed, and when the input is speech data, a process, such as that shown in the second embodiment, is performed.
In the process of the second embodiment, the threshold is changed, depending on the average value of levels of audio data.
When processes, such as those shown in the first to third embodiments, are performed, song position information is externally directly designated instead of song numbers.
When processes, such as those shown in the first to third embodiments, are performed, then if the result of song boundary detection based on the feature information obtained by the feature extraction signal processor 107 is different from the result of song boundary detection based on song numbers, the former is used with priority.
As in the example of FIG. 5, when sound interruption may occur in the beginning or end of a song no matter which frame boundary is used as a song boundary, sound interruption occurring in the beginning (or the end) of a song is avoided.

Thus, by controlling the details of the processes of the song boundary detector 106 and the feature extraction signal processor 107 from the external module which perform the division process, the determination of a song boundary can be optimized.

Note that the timing of control of the details of the processes of the song boundary detector 106 and the feature extraction signal processor 107 by the external module may be arbitrarily determined. For example, the control may be performed every time the system is activated, every time encoding is started, or during the encoding process. As the frequency at which the control of the details of the processes is performed is increased, the accuracy of the optimization increases, although the load of the system increases.

### INDUSTRIAL APPLICABILITY

As described above, the recording/reproduction device of the present invention advantageously reduces or prevents insertion of noise into the beginning or end of an encoded song when pieces of audio data having different song numbers are continuously input and reproduced, and at the same time, encoded data is divided and recorded according to song numbers.

1. A recording/reproduction device comprising:
an audio data processor configured to perform a decoding process for reproduction and a compression/encoding process for recording with respect to audio data in units of frames each containing a predetermined number of samples;
an encoded data buffer configured to temporarily accumulate encoded data output from the audio data processor;
a feature extraction signal processor configured to perform a signal process with respect to the audio data to extract feature information indicating a feature of the audio data;
a song boundary detector configured to receive song position information corresponding to the audio data and the feature information output from the feature extraction signal processor, and based on the song position information and the feature information, detect a frame boundary which should be used as a song boundary; and
a frame boundary divider configured to, when the song boundary detector detects a frame boundary which should be used as a song boundary, modify the encoded data accumulated in the encoded data buffer so that a frame boundary of the encoded data matches the detected frame boundary which should be used as a song boundary.

2. The recording/reproduction device of claim 1, wherein
the frame boundary divider outputs data indicating the frame boundary of the encoded data corresponding to the detected frame boundary which should be used as a song boundary, as a dividing position of the encoded data.

3. The recording/reproduction device of claim 1, wherein
the feature extraction signal processor extracts a feature amount of the audio data in a vicinity of a frame boundary as the feature information.

4. The recording/reproduction device of claim 3, wherein
the feature amount is a sound pressure level of the audio data.

5. The recording/reproduction device of claim 1, wherein
the feature extraction signal processor extracts, as the feature information, temporal transition information indicating temporal transition of a feature amount of the audio data.

6. The recording/reproduction device of claim 5, wherein
the temporal transition information is based on a result of comparison between the feature amount and a predetermined threshold.

7. The recording/reproduction device of claim 5, wherein
the feature amount is a sound pressure level of the audio data.

8. The recording/reproduction device of claim 5, wherein
the feature amount is a frequency characteristic of the audio data.

9. The recording/reproduction device of claim 5, wherein
the feature extraction signal processor performs physical characteristic analysis with respect to the audio data to obtain, as the feature amount, at least one of a result of determination of whether the audio data is audio or non-audio, tempo information, and timbre information.

10. The recording/reproduction device of claim 1, further comprising:
a host interface configured to allow external control of details of processes of the feature extraction signal processor and the song boundary detector.

11. The recording/reproduction device of claim 1, wherein
the audio data is recorded on a CD, and
the song position information contains a subcode recorded on the CD.
